(19) United States
(12) Patent Application Publication
(10) Pub. No.: US 2024/0214102 A1
(43) Pub. Date: Jun. 27, 2024

(54) PATH CONTROL DEVICE OF OPTICAL NETWORK, OPTICAL NETWORK SYSTEM, PATH CONTROL METHOD, AND PATH CONTROL PROGRAM

(71) Applicant: NEC Corporation, Minato-ku, Tokyo (JP)

(72) Inventor: Shigeyuki Yanagimachi, Tokyo (JP)

(73) Assignee: NEC Corporation, Minato-ku, Tokyo (JP)

(21) Appl. No.: 18/288,463

(22) PCT Filed: Mar. 15, 2022
(86) PCT No.: PCT/JP2022/011477

§ 371 Date: Oct. 26, 2023

(30) Foreign Application Priority Data
May 7, 2021 (JP) 2021-079303

(51) Int. Cl. H04J 14/02; H04B 10/27; H04Q 11/00

(52) U.S. Cl. CPC H04J 14/0212; H04B 10/27; H04Q 11/0005; H04Q 11/0062; H04Q 2011/0073

(57) ABSTRACT

A path control apparatus (100) includes a control section (10) that aggregates paths for a same receiving node into a same core of a same multi-core optical transmission channel.

### TECHNICAL FIELD

The present invention relates to a path control apparatus for an optical network, an optical network system, a path control method, and a path control program.

### BACKGROUND ART

In recent years, traffic flowing through networks continues to grow rapidly due to rapid spread of mobile terminals that are typified by smart phones and due to communication of large-volume data such as high-definition images as a result of sophistication of terminals. According to a certain survey, total download traffic of broadband subscribers in fiscal 2020 in Japan was approximately 19 Tbps, which continues to grow at an annual rate of approximately 57%, and the traffic is expected to continue to grow in the future. Under the circumstances, development of technology for increasing capacity has been underway in core networks that support large-capacity communication. Examples of such technologies include advanced modulation techniques such as: wavelength division multiplexing (WDM) that multiplexes a plurality of optical signals having different wavelengths and transmits the optical signals through a single optical fiber; dual polarization differential quadrature phase shift keying (DP-QPSK); and 16-quadrature amplitude modulation (16-QAM). However, the number of wavelengths available in WDM is limited, and it is therefore anticipated that, in the near future, the increase in communication capacity due to WDM will reach the peak. Signal S/N requirements are severe even for advanced modulation techniques. Therefore, the limit is approaching (e.g., a reaching distance is restricted). Under the circumstances, in recent years, in order to expand a transmission capacity per optical fiber, research and development of multi-core optical fibers (MCFs) in which a plurality of cores are provided in one cladding is also in progress, in place of conventional single-mode optical fibers (SMFs).

Thus, technological development for increasing capacity is steadily in progress, while technological development to effectively utilize limited frequency resources is also in progress. For example, in elastic accommodation technology, frequency utilization efficiency is enhanced by shortening a conventional WDM wavelength interval. Furthermore, in view of network control, for example, there is an approach in which frequency utilization efficiency is enhanced by reduction of path blocking, the reduction of path blocking being achieved by assigning a path in accordance with signal quality of an optical transmission channel, a band of a communication signal, and/or a communication distance.

In recent years, studies have been conducted on heterogeneous environment networks in which the foregoing MCFs are mixedly present with conventional SMFs.

Next, a network configuration using an MCF is illustrated in FIG. 17. The network is constituted by a plurality of nodes that switch paths of traffic. A connection form thereof can be a point-to-point form, a ring form, a mesh form, or the like. Next, an example of a configuration of a node is illustrated in FIG. 18. The node is constituted by: a fan-out that separates an input MCF for each single core (SMF); an optical amplifier that compensates a transmission loss; a switching element (wavelength selectable switch (WSS)) that switches a path for each wavelength while using a SMF as input; a fan-in that aggregates SMF outputs from the WSS into an MCF again; a plurality of transmitting and receiving apparatuses (transponder (TRPD)) that receive traffic from the WSS or transmit traffic to the WSS; a monitor that measures power and the like by partially branching off an optical signal passing through a SMF; and a control system that controls the components of the node.

There is a network in which two paths, i.e., an active system and a spare system are provided in order to quickly recover a failure if a failure such as a fiber disconnection occurs. At a node upstream of a failure part, a network management system (NMS) provides an instruction to switch the node so as to turn back from the active system to the spare system, and thus the failure part is bypassed and communication continues. For example, in a case of a network configuration in which four 4-core MCFs are used as an active system, the number of SMF-based fibers that are input to a node is 4 (number of cores)×4 (number of fibers)×2 (the active system and the spare system)=32. Thus, the number of fibers is greatly increased as compared with a network configuration using conventional SMFs.

Next, in the case of the network in which the four 4-core MCFs are used as an active system and which is used in the above estimation, each node needs 32 1×18 WSSs, 32 single-core optical amplifiers, and 16 protection switches for the active system only, assuming that non-blocking switches, add (insertion) ports for respective TRPDs, and drop (branch) ports for respective TRPDs are prepared so that all wavelengths in a core are switchable to all cores in all directions. In addition, when a spare system is taken into consideration, components twice as many as those are necessary, which leads to large problems of bloating of nodes and an increase in cost.

In precedent cases, for example, Patent Literature 1, Patent Literature 2, and Patent Literature 3 disclose cross-connect apparatuses in which an apparatus scale in a network using MCFs is reduced. In the configurations of these precedent cases, however, switching of each core of the MCF is possible but switching for each wavelength in each core is impossible.

Patent Literature 4 discloses a method for enhancing path accommodation efficiency by taking into consideration attributes (a transmitting node, a receiving node, a relay node, a distance, a band, and the like) of a path in an MCF network.

### CITATION LIST

### Patent Literature

### [Patent Literature 1]

Japanese Patent Application Publication Tokukai No. 2017-157983

### [Patent Literature 2]

Japanese Patent Application Publication Tokukai No. 2017-157982

### [Patent Literature 3]

Japanese Patent Application Publication Tokukai No. 2017-156444

### [Patent Literature 4]

Japanese Patent Application Publication Tokukai No. 2018-174417

### SUMMARY OF INVENTION

### Technical Problem

Under the circumstances, it is demanded to develop a technique that can carry out switching for each wavelength and that enhances path accommodation efficiency, while suppressing bloating of a node scale.

An example aspect of the present invention is accomplished in view of the above problems, and an example object thereof is to provide a technique that makes it possible to further enhance path accommodation efficiency while reducing a node scale in an optical network including a multi-core fiber.

### Solution to Problem

A path control apparatus in accordance with an example aspect of the present invention is a path control apparatus for controlling a path from a transmitting node to a receiving node in an optical network that includes a plurality of multi-core optical transmission channels each having a plurality of cores and a plurality of nodes connected to each other via the plurality of multi-core optical transmission channels, in which: each of the plurality of nodes includes a transmission and reception section, an optical switch section, and a wavelength selectable switch section, the transmission and reception section transmitting and receiving an optical signal, the optical switch section being connected to multi-core optical transmission channels and switching a path for each core, and the wavelength selectable switch section wavelength-selectively connecting the transmission and reception section to the optical switch section; and the path control apparatus includes a control section that aggregates paths for a same receiving node into a same core of a same multi-core optical transmission channel.

An optical network system in accordance with an example aspect of the present invention includes: a plurality of nodes that are connected to each other via a plurality of multi-core optical transmission channels each having a plurality of cores; and a path control apparatus that controls a path from a transmitting node to a receiving node in an optical network which includes the plurality of multi-core optical transmission channels and the plurality of nodes, each of the plurality of nodes including a transmission and reception section, an optical switch section, and a wavelength selectable switch section, the transmission and reception section transmitting and receiving an optical signal, the optical switch section being connected to multi-core optical transmission channels and switching a path for each core, and the wavelength selectable switch section wavelength-selectively connecting the transmission and reception section to the optical switch section, and the path control apparatus including a control section that aggregates paths for a same receiving node into a same core of a same multi-core optical transmission channel.

A path control method in accordance with an example aspect of the present invention is a path control method for controlling a path from a transmitting node to a receiving node in an optical network that includes a plurality of multi-core optical transmission channels each having a plurality of cores and a plurality of nodes connected to each other via the plurality of multi-core optical transmission channels, in which: each of the plurality of nodes includes a transmission and reception section, an optical switch section, and a wavelength selectable switch section, the transmission and reception section transmitting and receiving an optical signal, the optical switch section being connected to multi-core optical transmission channels and switching a path for each core, and the wavelength selectable switch section wavelength-selectively connecting the transmission and reception section to the optical switch section; and the path control method includes aggregating paths for a same receiving node into a same core of a same multi-core optical transmission channel.

A path control method in accordance with an example aspect of the present invention is a path control program for causing a computer to function as a path control apparatus for controlling a path from a transmitting node to a receiving node in an optical network that includes a plurality of multi-core optical transmission channels each having a plurality of cores and a plurality of nodes connected to each other via the plurality of multi-core optical transmission channels, in which: the path control program causes the computer to function as a control section that aggregates paths for a same receiving node into a same core of a same multi-core optical transmission channel; and each of the plurality of nodes includes a transmission and reception section, an optical switch section, and a wavelength selectable switch section, the transmission and reception section transmitting and receiving an optical signal, the optical switch section being connected to multi-core optical transmission channels and switching a path for each core, and the wavelength selectable switch section wavelength-selectively connecting the transmission and reception section to the optical switch section.

### Advantageous Effects of Invention

According to an example aspect of the present invention, it is possible to provide a technique for further enhancing path accommodation efficiency while reducing a node scale.

### BRIEF DESCRIPTION OF DRAWINGS

FIG. 1 is a view schematically illustrating an example of a configuration of an optical network system in accordance with a first example embodiment of the present invention.

FIG. 2 is a block diagram illustrating an example of a configuration of a path control apparatus provided in the optical network system in accordance with the first example embodiment of the present invention.

FIG. 3 is a block diagram illustrating an example of a configuration of a node provided in the optical network system in accordance with the first example embodiment of the present invention.

FIG. 4 is a flowchart illustrating an example flow of a path control method in accordance with the first example embodiment of the present invention.

FIG. 5 is a view schematically illustrating an example of a configuration of an optical network system in accordance with a second example embodiment of the present invention.

FIG. 6 is a structural diagram illustrating a 7-core multi-core optical fiber.

FIG. 7 is a structural diagram illustrating a 4-core uncoupled multi-core fiber.

FIG. 8 is a structural diagram illustrating a 4-core coupled multi-core fiber.

FIG. 9 is a configuration diagram illustrating a node in accordance with the second example embodiment of the present invention.

FIG. 10 is a block diagram illustrating a configuration of a path control apparatus in accordance with the second example embodiment of the present invention.

FIG. 11 is a conceptual diagram illustrating wavelength assignment in accordance with the second example embodiment of the present invention.

FIG. 12 is a flowchart illustrating an operation in accordance with the second example embodiment of the present invention.

FIG. 13 is a conceptual diagram illustrating wavelength assignment in accordance with a third example embodiment of the present invention.

FIG. 14 is a flowchart illustrating an operation in accordance with the third example embodiment of the present invention.

FIG. 15 is a configuration diagram illustrating a node in accordance with a fourth example embodiment of the present invention.

FIG. 16 is a block diagram illustrating an example of a hardware configuration of the path control apparatus in accordance with each of the example embodiments of the present invention.

FIG. 17 is a configuration diagram illustrating a network using an MCF.

FIG. 18 is a configuration diagram illustrating a node in an MCF network.

### EXAMPLE EMBODIMENTS

### First Example Embodiment

### <Configurations of System and Apparatus>

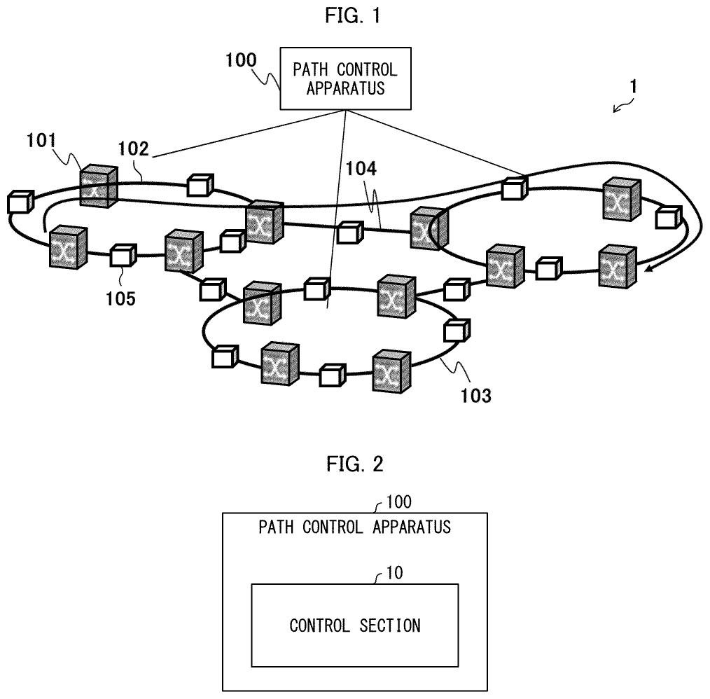

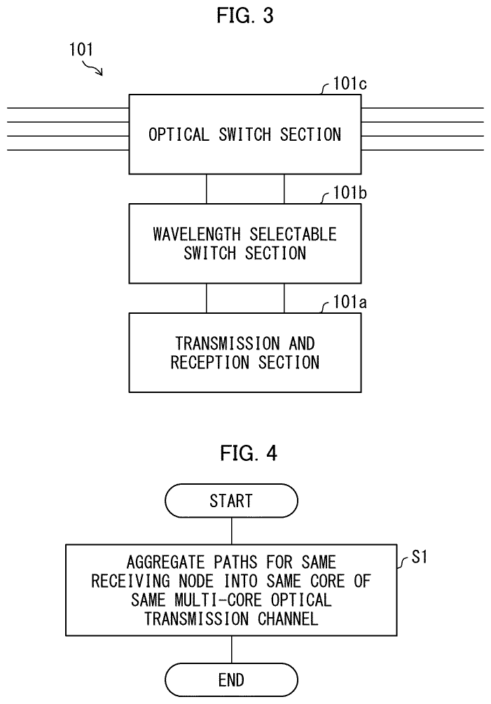

The following description will discuss configurations of an optical network system 1, a path control apparatus 100, and a node 101 in accordance with the present example embodiment, with reference to FIGS. 1 through 3. FIG. 1 is a view schematically illustrating an example of the configuration of the optical network system 1. FIG. 2 is a block diagram illustrating an example of a configuration of the path control apparatus 100. FIG. 3 is a block diagram illustrating an example of a configuration of the node 101.

The optical network system 1 is an optical network system which includes a multi-core optical fiber. In an example aspect, the optical network system 1 may be a heterogeneous optical network system in which a multi-core optical fiber and a single-core optical fiber are mixedly present.

As illustrated in FIG. 1, the optical network system 1 includes the path control apparatus 100, nodes 101, and an optical transmission channel 102.

The path control apparatus 100 is also referred to as “network management system (NMS)”, and controls the optical network system 1. In an example aspect, the path control apparatus 100 controls each of the nodes 101 and assigns a path from a transmitting node to a receiving node.

The optical transmission channel 102 is constituted by a plurality of rings 103 each of which connects a plurality of nodes 101 to each other, and a connection link 104 which connects the plurality of rings 103 to each other. The optical transmission channel 102 includes a multi-core optical transmission channel. The optical transmission channel 102 may be partially constituted by a multi-core optical transmission channel while partially constituted by a single-core optical transmission channel. Alternatively, the optical transmission channel 102 may be entirely constituted by a multi-core optical fiber.

As illustrated in FIG. 2, the path control apparatus 100 includes a control section 10.

The control section 10 aggregates paths for a same receiving node into a same core of a same multi-core optical transmission channel.

As illustrated in FIG. 3, the node 101 includes a transmission and reception section 101A, a wavelength selectable switch section 101B, and an optical switch section 101C.

The transmission and reception section 101A transmits and receives optical signals.

The optical switch section 101C is connected to a plurality of multi-core optical transmission channels, and switches a path for each core.

The wavelength selectable switch section 101B wavelength-selectively connects the transmission and reception section 101A to the optical switch section 101C.

### <Flow of Path Control Method>

The following description will discuss a flow of a path control method in accordance with the present example embodiment with reference to FIG. 4. FIG. 4 is a flowchart illustrating an example flow of the path control method in accordance with the present example embodiment. As illustrated in FIG. 4, the path control method in accordance with the present example embodiment includes at least step S1.

In step S1, the control section 10 controls, from a core provided in each of the optical transmission channels 102 in the optical network system 1, a path connecting a transmitting node to a receiving node, and the control section 10 aggregates paths for a same receiving node into a same core of a same multi-core optical transmission channel.

### Example Advantage of Present Example Embodiment

As described above, the optical path control apparatus 100 in accordance with the present example embodiment is configured to be a path control apparatus for controlling a path from a transmitting node to a receiving node in an optical network that includes a plurality of multi-core optical transmission channels each having a plurality of cores and a plurality of nodes connected to each other via the plurality of multi-core optical transmission channels, in which: each of the plurality of nodes includes a transmission and reception section, an optical switch 1 section, and a wavelength selectable switch section, the transmission and reception section transmitting and receiving an optical signal, the optical switch section being connected to multi-core optical transmission channels and switching a path for each core, and the wavelength selectable switch section wavelength-selectively connecting the transmission and reception section to the optical switch section; and the path control apparatus includes a control section that aggregates paths for a same receiving node into a same core of a same multi-core optical transmission channel.

An optical network system in accordance with the present example embodiment is configured to include: a plurality of nodes that are connected to each other via a plurality of multi-core optical transmission channels each having a plurality of cores; and a path control apparatus that controls a path from a transmitting node to a receiving node in an optical network which includes the plurality of multi-core optical transmission channels and the plurality of nodes, each of the plurality of nodes including a transmission and reception section, an optical switch section, and a wavelength selectable switch section, the transmission and reception section transmitting and receiving an optical signal, the optical switch section being connected to multi-core optical transmission channels and switching a path for each core, and the wavelength selectable switch section wavelength-selectively connecting the transmission and reception section to the optical switch section, and the path control apparatus including a control section that aggregates paths for a same receiving node into a same core of a same multi-core optical transmission channel.

The path control method in accordance with the present example embodiment can be configured to be a path control method for controlling a path from a transmitting node to a receiving node in an optical network that includes a plurality of multi-core optical transmission channels each having a plurality of cores and a plurality of nodes connected to each other via the plurality of multi-core optical transmission channels, in which: each of the plurality of nodes includes a transmission and reception section, an optical switch section, and a wavelength selectable switch section, the transmission and reception section transmitting and receiving an optical signal, the optical switch section being connected to multi-core optical transmission channels and switching a path for each core, and the wavelength selectable switch section wavelength-selectively connecting the transmission and reception section to the optical switch section; and the path control method includes aggregating paths for a same receiving node into a same core of a same multi-core optical transmission channel.

With the configurations, according to the path control apparatus 100, the optical network system 1, and the path control method in accordance with the present example embodiment, paths for the same receiving node are aggregated into the same core of a same multi-core optical transmission channel. Therefore, it is possible to minimize the number of cores in which a branch (drop) is needed to receive an optical signal at a receiving node. Therefore, even in a case where the receiving node has a non-blocking configuration, blocking can be suppressed. This makes it possible to further enhance path accommodation efficiency while reducing a node scale. As a result, it is possible to reduce costs of the whole of the optical network system.

Here, aggregating into a same core of a same multi-core optical transmission channel means to assign paths to a single core in a case where the paths can be accommodated in the single core. In addition, in a case where the number of paths to be aggregated is large and the paths cannot be accommodated in a single core, it is possible to assign the paths to a plurality of cores.

### Second Example Embodiment

The following description will discuss in detail a second example embodiment of the present invention, with reference to the drawings. Note that any constituent element that is identical in function to a constituent element described in the above example embodiment is given the same reference numeral, and a description thereof will be omitted where appropriate.

### <Configurations of System and Apparatus>

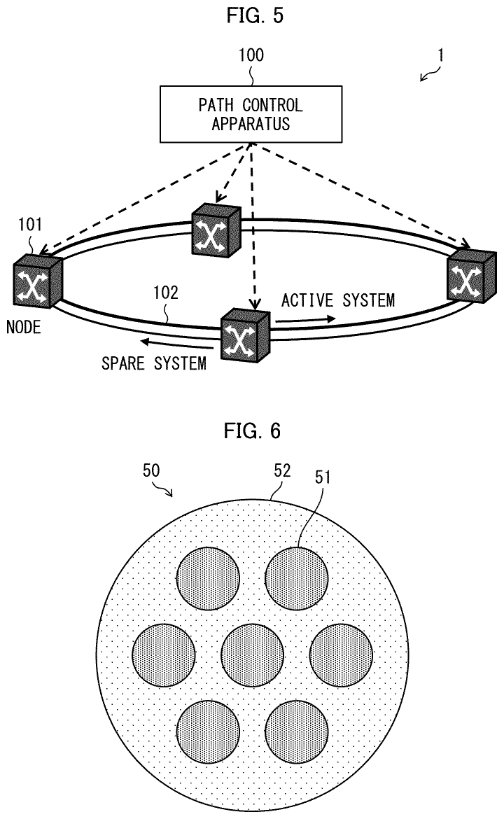

The following description will discuss the present example embodiment in detail with reference to FIG. 5 and the like. FIG. 5 illustrates a configuration of a heterogeneous optical network using an MCF.

An optical network system 1 and a path control apparatus 100 in accordance with the present example embodiment are configured as in the above first example embodiment. In the present example embodiment, the following description will discuss detailed configurations of the optical network system 1 and the path control apparatus 100.

The optical network system 1 is an optical network system that includes a multi-core optical fiber, which is a multi-core optical transmission channel. In an example aspect, the optical network system 1 may be a heterogeneous optical network system in which a multi-core optical fiber, which is a multi-core optical transmission channel, and a single-core optical fiber, which is a single-core optical transmission channel, are mixedly present. For example, the multi-core optical fiber may be an uncoupled multi-core optical fiber.

In the optical network system 1, as illustrated in FIG. 5, the path control apparatus 100 and a plurality of nodes 101 are connected to each other via an optical transmission channel 102.

In the present example embodiment, the optical transmission channel 102 is ring-shaped. However, the form of the optical transmission channel 102 is not limited to the ring shape, and may be another form such as a multi-ring shape or a mesh shape. For the optical transmission channel 102, two paths are provided, which are an active system and a spare system.

Note that a plurality of nodes and an optical amplifier (not illustrated) that compensates an optical transmission loss may be connected to each of the rings.

### (Multi-Core Optical Fiber)

FIG. 6 is a view illustrating a structure of a 7-core multi-core optical fiber as an example of a structure of a multi-core optical fiber. In the multi-core optical fiber 50 illustrated in FIG. 6, seven cores 51 are included in a single cladding 52. Note that multi-core optical fibers which have been developed are broadly divided into uncoupled multi-core optical fibers and coupled multi-core optical fibers.

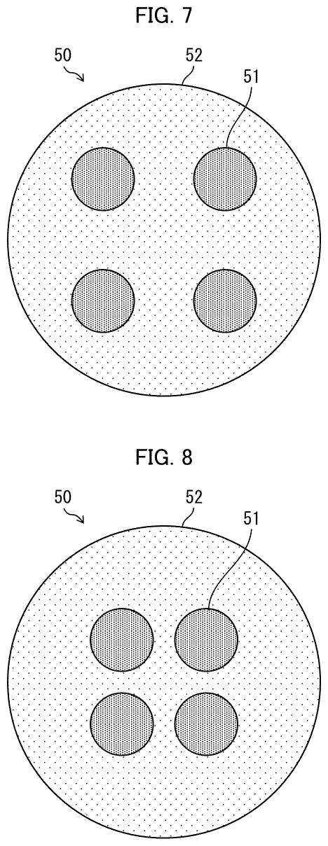

FIG. 7 illustrates a structure of a 4-core uncoupled multi-core optical fiber as an example of a structure of an uncoupled multi-core optical fiber. The uncoupled multi-core optical fiber 50 is an optical fiber in which a space is provided between adjacent cores 51 so that crosstalk between the cores 51 is reduced. In the uncoupled multi-core optical fiber 50, each core 51 can be used as an independent optical transmission channel. Therefore, it is possible to directly use optical communication technologies which have been developed for conventional single-core optical fibers.

FIG. 8 illustrates a structure of a 4-core coupled multi-core optical fiber as an example of a structure of a coupled multi-core optical fiber. The coupled multi-core optical fiber is an optical fiber in which a high core density is realized by narrowing a space between adjacent cores 51. In the coupled multi-core optical fiber, since crosstalk occurs between each pair of cores 51, a multi-input multi-output (MIMO) process with use of a digital signal processor (DIP) or the like is needed in an optical receiver.

In the present example embodiment, the 4-core uncoupled multi-core optical fiber illustrated in FIG. 7 is used as the multi-core optical fiber which constitutes an optical transmission channel 102. Note, however, that the number of cores is not limited to four (4-core).

### (Nodes)

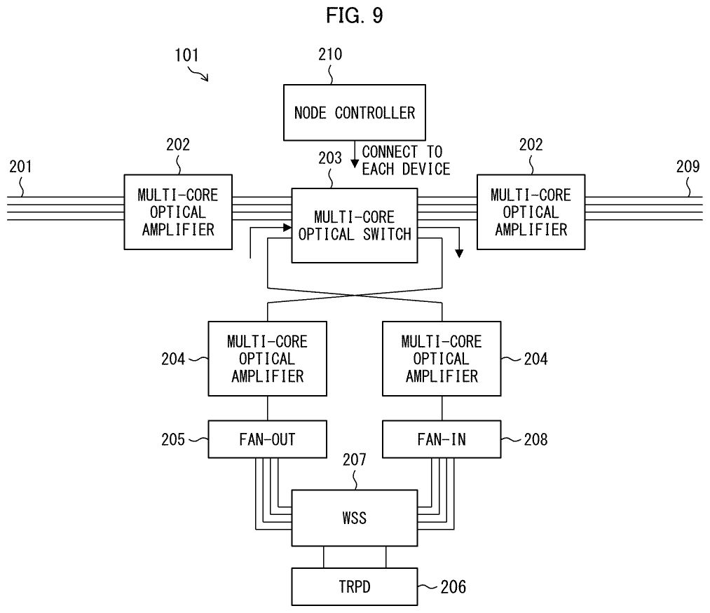

FIG. 9 is a block diagram illustrating an example of a configuration of nodes 101 for use in the present example embodiment. Each of the nodes 101 includes, for example, an input MCF 201, a transmission loss compensation multi-core optical amplifier 202, a multi-core optical switch 203, a node loss compensation multi-core optical amplifier 204, a fan-out 205, a TRPD 206, a WSS 207, a fan-in 208, an output MCF 209, and a node controller 210.

The node 101 includes, in an order of optical signal flow:
the transmission loss compensation multi-core optical amplifier 202 that compensates a transmission loss of the input MCF 201 for each multi-core fiber;
the multi-core optical switch 203 that switches between cores of an MCF from the multi-core optical amplifier 202;
the node loss compensation multi-core optical amplifier 204 that compensates a loss of an optical signal from a drop (branch) port of the multi-core optical switch 203;
the fan-out 205 that separates an optical signal for each MCF from the node loss compensation multi-core optical amplifier 204 into optical signals for respective SMFs (i.e., for respective single cores);
the WSS 207 that switches, for each wavelength, the optical signal for each SMF (i.e., for each single core) from the fan-out 205, and carries out addition (insertion)/drop (branch) to the TRPD 206 that transmits and receives an optical signal;
the fan-in 208 that aggregates optical signals for respective SMFs (i.e., for respective single cores) from the WSS 207 into an MCF;
the node loss compensation multi-core optical amplifier 204 that compensates a loss of an optical signal for each MCF from the fan-in 208;
the multi-core optical switch 203 that receives, at the add port, an optical signal of the node loss compensation multi-core optical amplifier 204 and carries out switching between cores;
the transmission loss compensation multi-core optical amplifier 202 that compensates a loss of an optical signal from the multi-core optical switch 203;
the output MCF 209 that transmits an optical signal from the transmission loss compensation multi-core optical amplifier 202; and
the node controller 210 that controls each of the devices in the node.

Note that the TRPD 206, the multi-core optical switch 203, and the WSS 207 are specific examples of the transmission and reception section, the optical switch section, and the wavelength selectable switch section in the claims, respectively.

The multi-core optical switch 203 is connected to a plurality of multi-core optical fibers, and switches a path for each core. For example, the multi-core optical switch 203 is configured to directly accommodate the multi-core optical fibers.

The WSS 207 wavelength-selectively connects the TRPD 206 to the multi-core optical switch 203.

For example, assuming that the number of cores of each of the input MCF 201 and the output MCF 209 is four and the number of MCFs is four, the transmission loss compensation multi-core optical amplifier 202 serves as an optical amplifier that compensates 19 cores. Moreover, assuming that the number of add (insertion) port is one, the number of drop (branch) port is one (an add/drop ratio is equivalent to 25%), and the number of protection port is one, the number of multi-core optical switches 203 is 6×6. The node loss compensation multi-core optical amplifier 204 serves as an optical amplifier that compensates four cores because the node loss compensation multi-core optical amplifier 204 only needs to compensate one MCF having four cores.

To an SMF, a tap coupler (not illustrated) is attached. The tap coupler causes a portion of an optical signal to branch off. The portion of the optical signal having branched off via the tap coupler is input to a monitor (not illustrated). The node controller 210 controls the multi-core optical switch 203 and the WSS 207, according to monitor information which has been received from the monitor.

Note that, in the present example embodiment, the WSS 207 is a multi-core optical switch to which a plurality of multi-core optical fibers are directly connected. The WSS 207 is not limited to this, and can be configured to be connected to multi-core optical fibers indirectly (i.e., via a fan-out and a single-core fiber).

### (Path Control Apparatus)

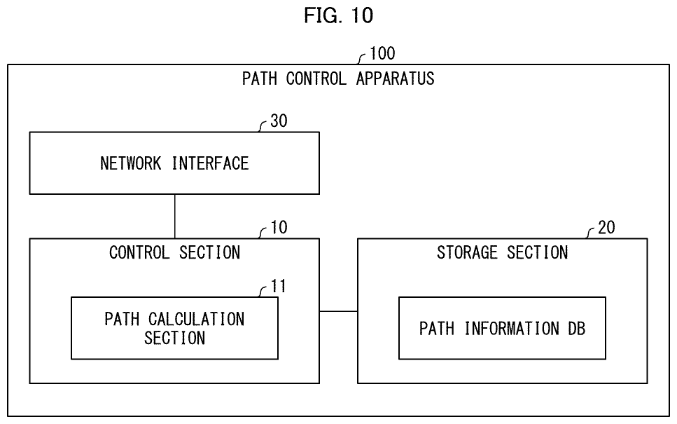

FIG. 10 is a block diagram illustrating an example of a configuration of a path control apparatus in accordance with the present example embodiment. The path control apparatus is basically configured as described in the foregoing first example embodiment. Note, however, that the control section 10 further includes a path calculation section 11. Moreover, a storage section 20 stores a path information database (path information DB).

The path calculation section 11 carries out path calculation with reference to the path information database. The path calculation section 11 extracts, for example, unused cores from among a plurality of MCFs which are usable from a transmitting node to a receiving node.

### <Flow of Path Control Method>

The following description will discuss a path control method in accordance with the present example embodiment. This method is carried out by the path control apparatus 100 in accordance with the present example embodiment. In this method, a case will be described in which there is a direct path from the transmitting node to the receiving node.

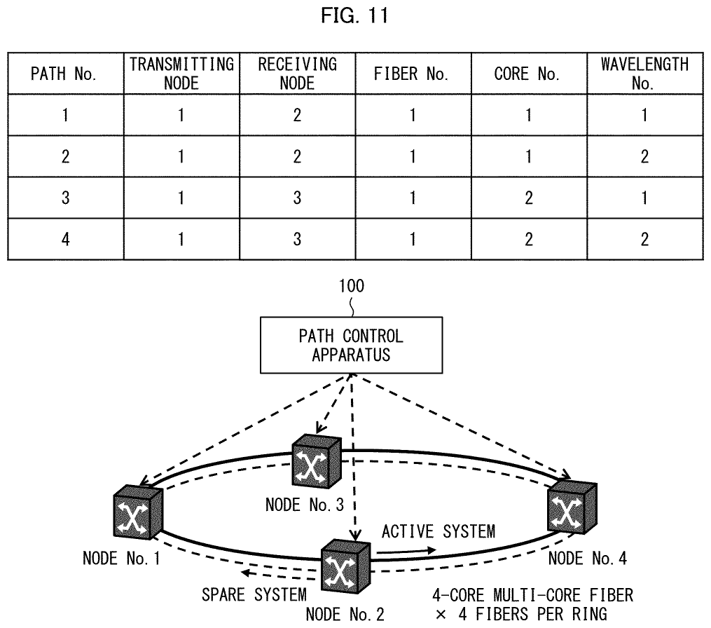

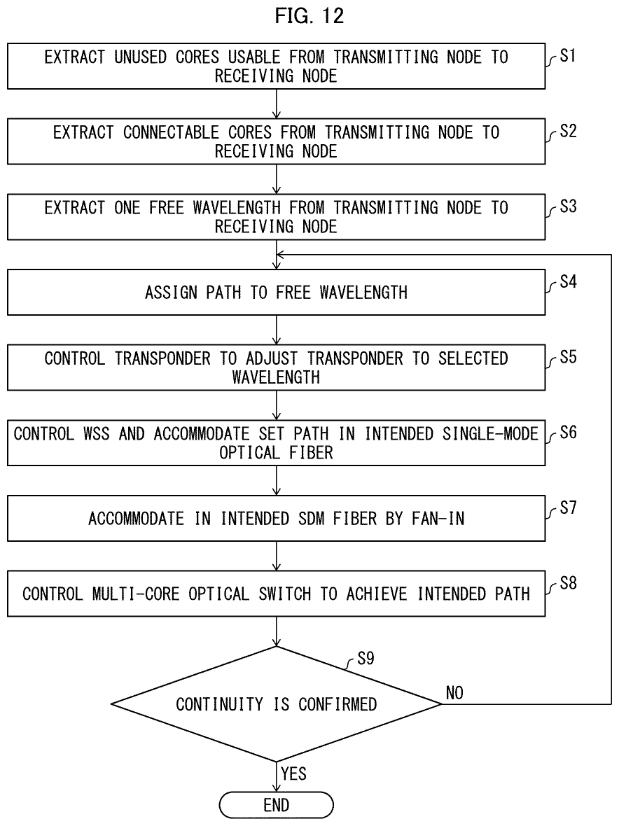

FIG. 11 is a conceptual diagram illustrating wavelength assignment, and FIG. 12 is a flowchart illustrating an operation.

First, when a path request is issued, the path calculation section 11 in the control section 10 of the path control apparatus 100 refers to the path information database (path information DB) stored in the storage section 20 and extracts unused cores from among a plurality of MCFs usable from the transmitting node to the receiving node (step S1).

Next, the control section 10 extracts, from among the unused cores which have been extracted in step S1, cores which are connectable from the transmitting node to the receiving node (step S2).

Next, the control section 10 extracts, in the connectable cores which have been extracted in step S2, one free wavelength from the transmitting node to the receiving node (step S3).

Next, the control section 10 assigns a path to the free wavelength which has been extracted in step S3 (step S4). At this time, for example, as illustrated in FIG. 11, a same receiving node (path No. 1 and path No. 2, and path No. 3 and path No. 4) is assigned to a same core of a same fiber.

Next, under control of the control section 10, the node controller 210 at the node 101 (transmitting node) controls the transponder 206 to adjust the transponder 206 to the selected wavelength (step S5).

Next, the node controller 210 controls the WSS 207 so that a set path is accommodated in an intended single-mode optical fiber (step S6).

Next, the path is accommodated in an intended SDM fiber by the fan-in 208 (step S7).

Next, the node controller 210 controls the multi-core optical switch 203 to switch the path so that the assignment in the above step S4 is achieved (step S8).

Next, signaling is carried out for confirming continuity of the path (step S9). If signal communication is impossible, the process is carried out again from the assignment of another wavelength (step S4). If signal communication is confirmed, the operation is completed (END).

### Example Advantage of Present Example Embodiment

Thus, paths for the same receiving node are aggregated into a single core of a single fiber. Therefore, it is possible to minimize the number of cores in which a branch (drop) is needed to receive an optical signal at a receiving node. Therefore, even in the node 101 having a small number of drop ports, it is possible to reduce a probability of blocking, and it is possible to improve path accommodation efficiency. As a result, it is possible to reduce costs of the whole of the optical network system.

### Third Example Embodiment

The following description will discuss a third example embodiment of the present invention in detail with reference to the drawings. Note that any constituent element that is identical in function to a constituent element described in the above example embodiments is given the same reference numeral, and a description thereof will be omitted where appropriate.

Configurations of the system and the apparatus are basically identical with those of the above-described second example embodiment. Note, however, that the transponder 206 used in the present example embodiment is a wavelength-variable transponder that is c capable of selectively outputting different wavelengths.

### <Flow of Path Control Method>

The following description will discuss a path control method in accordance with the present example embodiment. In this method, a case will be described in which there is no direct path from the transmitting node to the receiving node.

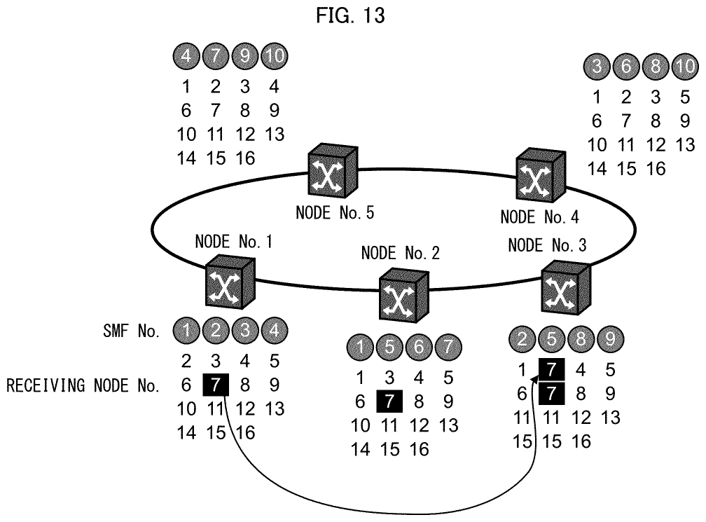

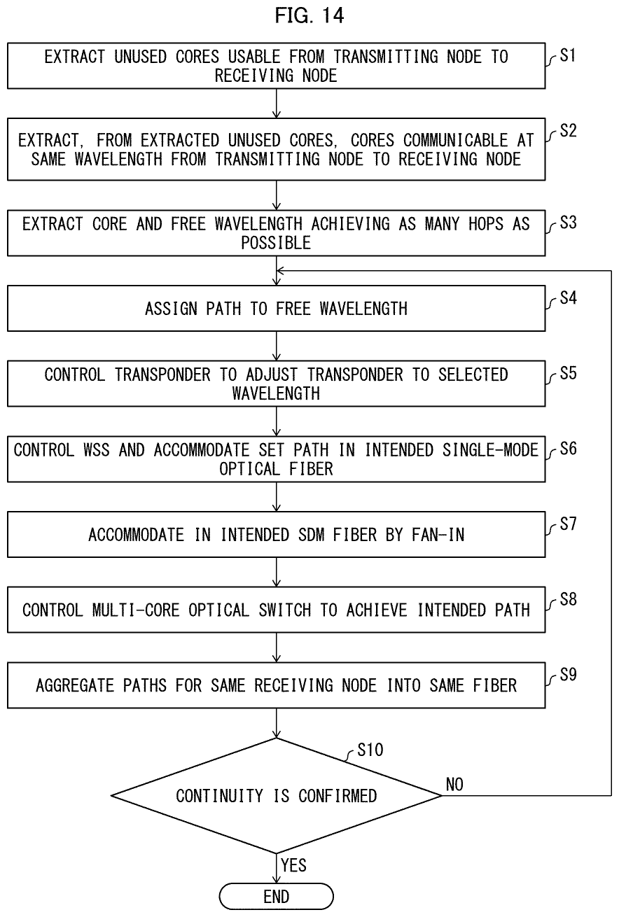

FIG. 13 is a conceptual diagram illustrating wavelength assignment, and FIG. 14 is a flowchart illustrating an operation.

First, when a path request is issued, the path calculation section 11 in the control section 10 of the path control apparatus 100 refers to the path information database (path information DB) stored in the storage section 20 and extracts unused cores from among a plurality of MCFs usable from the transmitting node to the receiving node (step S1 in FIG. 14).

Next, the control section 10 extracts, from among the unused cores which have been extracted in step S1, cores which are connectable from the transmitting node to the receiving node (step S2).

Next, the control section 10 extracts, in the connectable cores which have been extracted in step S2, one free wavelength having a greatest possible hop count from the transmitting node to the receiving node (step S3).

Next, the control section 10 assigns a path to the free wavelength which has been extracted in step S3 (step S4). At this time, the control section 10 may assign a path that includes wavelength switching at the relay node.

Next, under control of the control section 10, the node controller 210 at the node 101 (transmitting node) controls the transponder 206 to adjust the transponder 206 to the selected wavelength (step S5).

Next, the node controller 210 controls the WSS 207 so that a set path is accommodated in an intended single-mode optical fiber (step S6).

Next, the path is accommodated in an intended SDM fiber by the fan-in 208 (step S7).

Next, the node controller 210 controls the multi-core optical switch 203 to switch the path so that the assignment in the above step S4 is achieved (step S8).

Next, an operation at the relay node (aggregation of paths for a same receiving node into a same fiber: step S9) will be described with reference to FIG. 13. FIG. 13 illustrates numbers (SMF fiber No.) of SMF fibers (single core) in which drop (branch) and addition (insertion) are carried out at each node 101 and numbers (receiving node No.) of receiving nodes of respective paths assigned to each SMF fiber (single core) in which addition (insertion) is carried out at each node 101.

First, at a node No. 1 (transmitting node), links for four SMF units (single core units) can be accommodated. Therefore, paths for receiving nodes No. 2, 6, 10, and 14 are assigned to an SMF (single core) No. 1, paths for receiving nodes No. 3, 7, 11, and 15 are assigned to an SMF (single core) No. 2, paths for receiving nodes No. 4, 8, 12, and 16 are assigned to an SMF (single core) No. 3, and paths for receiving nodes No. 4, 9, and 12 are assigned to an SMF (single core) No. 4. Note that paths assigned to the same SMF (single core) are assigned to wavelengths different from each other.

Similarly, in a node No. 2 (relay node), an SMF (single core) No. 1 includes a path for the node No. 2. Therefore, the path is dropped (branched) at the node No. 2, and another path (in this case, a path for a receiving node 1) is inserted in place of the path for the node No. 2. Here, paths for receiving nodes No. 1, 6, 10, and 14 are assigned to the SMF (single core) No. 1, paths for receiving nodes No. 3, 7, 11, and 15 are assigned to an SMF (single core) No. 5, paths for receiving nodes No. 4, 8, 12, and 16 are assigned to an SMF (single core) No. 6, and paths for receiving nodes No. 4, 9, and 12 are assigned to an SMF (single core) No. 7. In the above case, a path for the receiving node No. 7 is separated to the SMF No. 2 and the SMF No. 5.

Next, at a node No. 3 (relay node), a fiber No. 2 and a fiber No. 5 are dropped (branched) to the WSS 207, and the paths for the receiving node No. 7 added at the node 1 and the node 2 are aggregated into a fiber No. 5 by the WSS 207. For example, the path for the node No. 3 that has been assigned to the fiber No. 5 is dropped (branched) at the node No. 3, and the path for the node No. 7 that has been assigned to the fiber No. 2 is instead added (inserted) to the fiber No. 5 after the wavelength is switched in the TRPD 206. The above operation is carried out when the node controller 210 of each of the nodes 101 that are controlled by the control section 10 of the path control apparatus 100 controls the multi-core optical switch 203, the TRPD 206, and the WSS 207.

Thus, a path for a same receiving node added at another node is selectively aggregated each time of passing through a node (i.e., a path for a same receiving node is assigned to a same core). As a result, paths for the same receiving node are aggregated into a single fiber. Therefore, it is possible to minimize the number of cores in which a branch (drop) is needed to receive an optical signal at a receiving node. Therefore, even in the node configuration having a small number of drop ports, it is possible to reduce a probability of blocking, and it is possible to improve path accommodation efficiency. As a result, it is possible to reduce costs of the whole of the optical network system.

Next, signaling is carried out for confirming continuity of the path (step S10). If signal communication is impossible, the process is carried out again from the assignment of another wavelength (step S4). If signal communication is confirmed, the operation is completed (END).

### Fourth Example Embodiment

The following description will discuss a fourth example embodiment of the present invention in detail with reference to the drawings. Note that any constituent element that is identical in function to a constituent element described in the above example embodiments is given the same reference numeral, and a description thereof will be omitted where appropriate.

In the present example embodiment, a configuration of a node is different from that in the other example embodiments. Therefore, only the configuration of the node will be described. Note that the configuration of the path control apparatus 100 and the path control method are identical with the operation flow described in the above second example embodiment or third example embodiment.

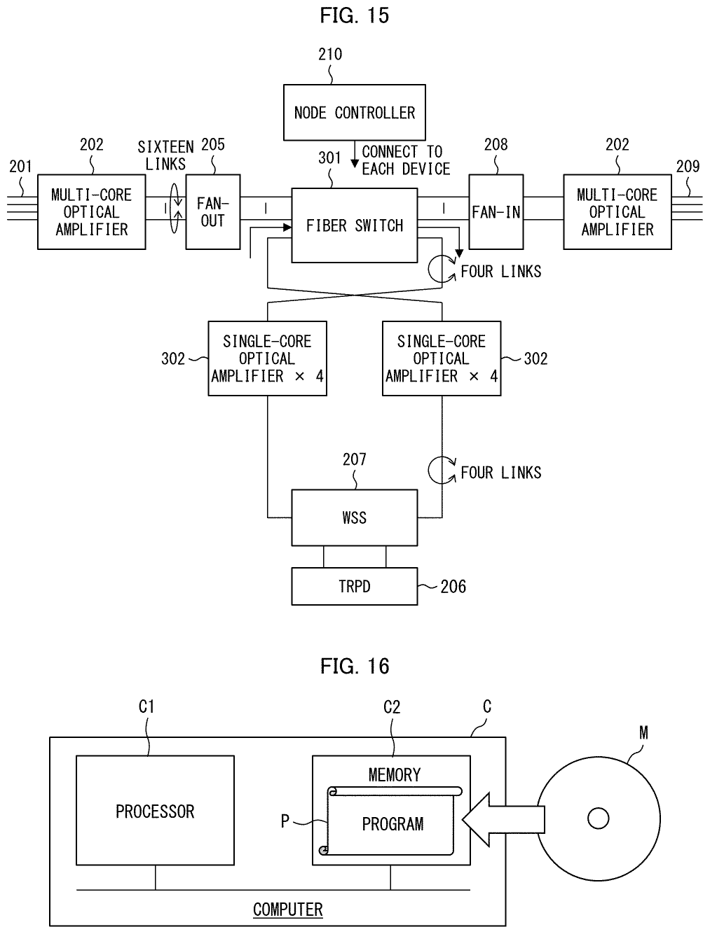

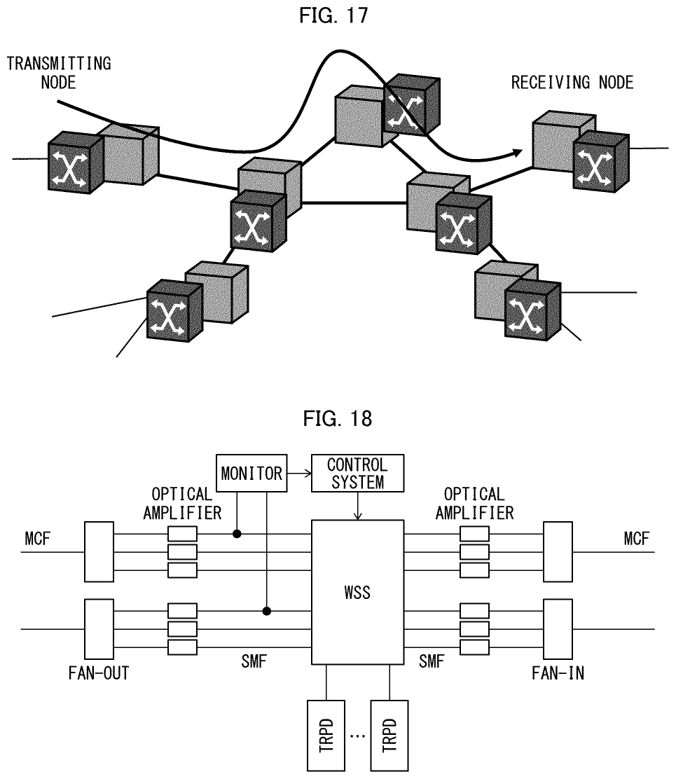

FIG. 15 is a block diagram illustrating an example of nodes 101 for use in the present example embodiment. For example, each of the nodes 101 includes:
an input MCF 201;
   a transmission loss compensation multi-core optical amplifier 202 that compensates a transmission loss of the input MCF 201 for each multi-core fiber;
a fan-out 205 that separates an optical signal for each MCF from the transmission loss compensation multi-core optical amplifier 202 into optical signals for respective SMFs;
   a fiber switch 301 that switches optical signals for respective SMFs from the fan-out 205;
a node loss compensation single-core optical amplifier 302 that compensates a loss of an optical signal from a drop (branch) port of the fiber switch 301;
a WSS 207 that switches, for each wavelength, an optical signal for each SMF from the node loss compensation single-core optical amplifier 302 and carries out addition (insertion)/drop (branch) to the TRPD 206;
a node loss compensation single-core optical amplifier 302 that compensates a loss of an optical signal for each SMF from the WSS 207;
a fan-in 208 that aggregates optical signals for respective SMFs from the fiber switch 301 into an MCF;
   a transmission loss compensation multi-core optical amplifier 202 that compensates a loss of an optical signal for each MCF from the fan-in 208;
an output MCF 209 that transmits an optical signal from the transmission loss compensation multi-core optical amplifier 202;
a TRPD 206; and
a node controller 210 that controls each of the devices in the node.

Note that the fan-out 205 is a specific example of the separation section in the claims. The fiber switch 301 accommodates the input MCF 201 after the input MCF 201 is separated for each single core by the fan-out 205.

In an optical network system having the node configuration in which the multi-core optical switch 203 is replaced with the fiber switch 301 as in the present example embodiment also, paths for a same receiving node are aggregated into a single core by the path control apparatus. Accordingly, it is possible to reduce a probability of occurrence of blocking, and thus it is possible to improve path accommodation efficiency. Note, however, that the node configuration in which the multi-core optical switch 203 is used can reduce the number of optical amplifiers, fan-ins, fan-outs, and the like more than the node configuration in which the fiber switch 301 is used.

### [Software Implementation Example]

The functions of part of or all of the path control apparatus 100 can be realized by hardware such as an integrated circuit (IC chip) or can be alternatively realized by software.

In the latter case, the path control apparatus 100 is realized by, for example, a computer that executes instructions of a program that is software realizing the foregoing functions. FIG. 16 illustrates an example of such a computer (hereinafter, referred to as “computer C”). The computer C includes at least one processor C1 and at least one memory C2. The memory C2 stores a program P for causing the computer C to function as the path control apparatus 100. In the computer C, the processor C1 reads the program P from the memory C2 and executes the program P, so that the functions of the path control apparatus 100 are realized.

Examples of the processor C1 encompass a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the memory C2 encompass a flash memory, a hard disk drive (HDD), a solid state drive (SSD), and a combination thereof.

Note that the computer C can further include a random access memory (RAM), in which the program P is loaded when the program P is to be executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a non-transitory tangible storage medium M which is readable by the computer C. Examples of such a storage medium M can include a tape, a disk, a card, a semiconductor memory, and a programmable logic circuit. The computer C can obtain the program P via the storage medium M. Alternatively, the program P can be transmitted via a transmission medium. Examples of such a transmission medium can include a communication network and a broadcast wave. The computer C can also obtain the program P via the transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

Some or all of the foregoing example embodiments can also be described as below. Note, however, that the present invention is not limited to the following supplementary notes.

### (Supplementary Note 1)

A path control apparatus for controlling a path from a transmitting node to a receiving node in an optical network that includes a plurality of multi-core optical transmission channels each having a plurality of cores and a plurality of nodes connected to each other via the plurality of multi-core optical transmission channels, in which: each of the plurality of nodes includes a transmission and reception section, an optical switch section, and a wavelength selectable switch section, the transmission and reception section transmitting and receiving an optical signal, the optical switch section being connected to multi-core optical transmission channels and switching a path for each core, and the wavelength selectable switch section wavelength-selectively connecting the transmission and reception section to the optical switch section; and the path control apparatus includes a control section that aggregates paths for a same receiving node into a same core of a same multi-core optical transmission channel.

According to the configuration, it is possible to further enhance path accommodation efficiency while reducing a node scale. As a result, it is possible to reduce costs of the whole of the optical network system.

### (Supplementary Note 2)

The path control apparatus according to supplementary note 1, in which: the control section aggregates, at the transmitting node, paths for a same receiving node into a same core of a same multi-core optical transmission channel.

According to the configuration, it is possible to further enhance path accommodation efficiency while reducing a node scale of the transmitting node. As a result, it is possible to reduce costs of the whole of the optical network system.

### (Supplementary Note 3)

The path control apparatus according to supplementary note 1 or 2, in which: the control section aggregates, at a relay node that relays the transmitting node to the receiving node, paths for a same receiving node into a same core of a same multi-core optical transmission channel via the wavelength selectable switch section.

According to the configuration, it is possible to further enhance path accommodation efficiency while reducing a node scale of the relay node. As a result, it is possible to reduce costs of the whole of the optical network system.

### (Supplementary Note 4)

The path control apparatus according to any one of supplementary notes 1 through 3, in which: the optical switch section directly accommodates the multi-core optical transmission channels.

According to the configuration, even in an example aspect in which the optical switch section directly accommodates the multi-core optical transmission channels, the control section aggregates paths for a same receiving node into a same core of a same multi-core optical transmission channel. Therefore, it is possible to further enhance path accommodation efficiency while reducing a node scale.

### (Supplementary Note 5)

The path control apparatus according to any one of supplementary notes 1 through 3, in which: each of the plurality of nodes includes a separation section that separates each of the multi-core optical transmission channels for each single core; and the optical switch section accommodates the multi-core optical transmission channels each of which has been separated for each single core by the separation section.

According to the configuration, even in an example aspect in which the optical switch section accommodates the multi-core optical transmission channels each of which has been separated for each single core by the separation section, the control section aggregates paths for a same receiving node into a same core of a same multi-core optical transmission channel. Therefore, it is possible to further enhance path accommodation efficiency while reducing a node scale.

### (Supplementary Note 6)

The path control apparatus according to any one of supplementary notes 1 through 5, further including: a storage section that stores a path information database, the control section carrying out path calculation with reference to the path information database.

According to the configuration, the control section aggregates paths for a same receiving node into a same core of a same multi-core optical transmission channel with reference to the path information database.

### (Supplementary Note 7)

An optical network system, including: a plurality of nodes that are connected to each other via a plurality of multi-core optical transmission channels each having a plurality of cores; and a path control apparatus that controls a path from a transmitting node to a receiving node in an optical network which includes the plurality of multi-core optical transmission channels and the plurality of nodes, each of the plurality of nodes including a transmission and reception section, an optical switch section, and a wavelength selectable switch section, the transmission and reception section transmitting and receiving an optical signal, the optical switch section being connected to multi-core optical transmission channels and switching a path for each core, and the wavelength selectable switch section wavelength-selectively connecting the transmission and reception section to the optical switch section, and the path control apparatus including a control section that aggregates paths for a same receiving node into a same core of a same multi-core optical transmission channel.

This method yields an example advantage similar to that of supplementary note 1.

### (Supplementary Note 8)

A path control method for controlling a path from a transmitting node to a receiving node in an optical network that includes a plurality of multi-core optical transmission channels each having a plurality of cores and a plurality of nodes connected to each other via the plurality of multi-core optical transmission channels, in which: each of the plurality of nodes includes a transmission and reception section, an optical switch section, and a wavelength selectable switch section, the transmission and reception section transmitting and receiving an optical signal, the optical switch section being connected to multi-core optical transmission channels and switching a path for each core, and the wavelength selectable switch section wavelength-selectively connecting the transmission and reception section to the optical switch section; and the path control method includes aggregating paths for a same receiving node into a same core of a same multi-core optical transmission channel.

This method yields an example advantage similar to that of supplementary note 1.

### (Supplementary Note 9)

A path control program for causing a computer to function as a path control apparatus for controlling a path from a transmitting node to a receiving node in an optical network that includes a plurality of multi-core optical transmission channels each having a plurality of cores and a plurality of nodes connected to each other via the plurality of multi-core optical transmission channels, in which: the path control program causes the computer to function as a control section that aggregates paths for a same receiving node into a same core of a same multi-core optical transmission channel; and each of the plurality of nodes includes a transmission and reception section, an optical switch section, and a wavelength selectable switch section, the transmission and reception section transmitting and receiving an optical signal, the optical switch section being connected to multi-core optical transmission channels and switching a path for each core, and the wavelength selectable switch section wavelength-selectively connecting the transmission and reception section to the optical switch section.

This program yields an example advantage similar to that of supplementary note 1.

### [Additional Remark 3]

This application claims priority based on Japanese Paten Application No. 2021-079303, which was filed on May 7, 2021, and the disclosure thereof is hereby incorporated by reference in its entirety.

### REFERENCE SIGNS LIST

1: Optical network system
10: Control section
20: Storage section
100: Path control apparatus
101: Node
203: Multi-core optical switch (optical switch section)
205: Fan-out (separation section)
206: TRPD (transmission and reception)
207: WSS (wavelength selectable switch section)

What is claimed is:

1. A path control apparatus for controlling a path from a transmitting node to a receiving node in an optical network that includes a plurality of multi-core optical transmission channels each having a plurality of cores and a plurality of nodes connected to each other via the plurality of multi-core optical transmission channels, wherein:
each of the plurality of nodes includes a transmission and reception section, an optical switch section, and a wavelength selectable switch section, the transmission and reception section transmitting and receiving an optical signal, the optical switch section being connected to multi-core optical transmission channels and switching a path for each core, and the wavelength selectable switch section wavelength-selectively connecting the transmission and reception section to the optical switch section; and
said path control apparatus comprises at least one processor, the at least one processor carrying out a control process of aggregating paths for a same receiving node into a same core of a same multi-core optical transmission channel.

2. The path control apparatus according to claim 1, wherein:
in the control process, the at least one processor aggregates, at the transmitting node, paths for a same receiving node into a same core of a same multi-core optical transmission channel.

3. The path control apparatus according to claim 1, wherein:
in the control process, the at least one processor aggregates, at a relay node that relays the transmitting node to the receiving node, paths for a same receiving node into a same core of a same multi-core optical transmission channel via the wavelength selectable switch section.

4. The path control apparatus according to claim 1, wherein:
the optical switch section directly accommodates the multi-core optical transmission channels.

5. The path control apparatus according to claim 1, wherein:
each of the plurality of nodes includes a separation section that separates each of the multi-core optical transmission channels for each single core; and
the optical switch section accommodates the multi-core optical transmission channels each of which has been separated for each single core by the separation section.

6. The path control apparatus according to claim 1, further comprising:
a storage section that stores a path information database,
in the control process, the at least one processor carrying out path calculation with reference to the path information database.

7. An optical network system, comprising:
a plurality of nodes that are connected to each other via a plurality of multi-core optical transmission channels each having a plurality of cores; and
a path control apparatus that controls a path from a transmitting node to a receiving node in an optical network which includes the plurality of multi-core optical transmission channels and the plurality of nodes,
each of the plurality of nodes including a transmission and reception section, an optical switch section, and a wavelength selectable switch section, the transmission and reception section transmitting and receiving an optical signal, the optical switch section being connected to multi-core optical transmission channels and switching a path for each core, and the wavelength selectable switch section wavelength-selectively connecting the transmission and reception section to the optical switch section, and
the path control apparatus including at least one processor that carries out a control process of aggregating paths for a same receiving node into a same core of a same multi-core optical transmission channel.

8. A path control method for controlling a path from a transmitting node to a receiving node in an optical network that includes a plurality of multi-core optical transmission channels each having a plurality of cores and a plurality of nodes connected to each other via the plurality of multi-core optical transmission channels, wherein:
each of the plurality of nodes includes a transmission and reception section, an optical switch section, and a wavelength selectable switch section, the transmission and reception section transmitting and receiving an optical signal, the optical switch section being connected to multi-core optical transmission channels and switching a path for each core, and the wavelength selectable switch section wavelength-selectively connecting the transmission and reception section to the optical switch section; and
said path control method comprises aggregating paths for a same receiving node into a same core of a same multi-core optical transmission channel.

9. (canceled)
